(19) United States
(12) Patent Application Publication
(10) Pub. No.: US 2012/0005694 A1
(43) Pub. Date: Jan. 5, 2012

(54) Anti-breakage tray structure of optical disc drive

(75) Inventors: Guan-De Liou, Taipei City (TW); Stephen Tsai, Sijhih City (TW); Shao-Yu Hwang, Taipei City (TW)

(73) Assignee: Hannspree, Inc., Taipei County (TW)

(21) Appl. No.: 12/923,460

(22) Filed: Sep. 23, 2010

(30) Foreign Application Priority Data
Jun. 30, 2010 (CN) 201010222697.9

(51) Int. Cl. G11B 17/03

(52) U.S. Cl. 720/601; G9B/17.009

(57) ABSTRACT

The present invention is to provide a breakproof tray structure of an optical disc drive, which includes a tray and a resilient member. The resilient member has one side connected to an end of the tray and an opposite side connected to a loading/ejecting mechanism of the optical disc drive. The resilient member is made of a flexible material such as rubber. Thus, when the tray is subjected to an external force while being pushed out from an opening of the optical disc drive by the loading/ejecting mechanism, the resilient member will deform elastically for absorbing the external force and support the tray Effectively preventing the tray from being damaged by the external force and, once the external force is removed, the resilient member will return to its original shape for allowing the tray to be pushed back into the optical disc drive by the loading/ejecting mechanism through the opening.

### FIELD OF THE INVENTION

The present invention relates to a tray structure of an optical disc drive, more particularly to a breakproof tray structure including a resilient member having one side connected to an end of a tray of the optical disc drive and an opposite side connected to a loading/ejecting mechanism of the optical disc drive, so as to utilize the resilient member to absorb an external force and support the tray. Effectively prevent the tray from being damaged by the external force.

### BACKGROUND OF THE INVENTION

As personal computers (PCs) become increasingly popular, more and more people have PCs at home or in the office. In order for the computer to access a storage medium such as an optical disc (e.g., CD and DVD), an optical disc drive is typically installed in the chassis of the computer, or an external optical disc drive is connected to a connection port of the computer. Generally, an optical disc drive is operated in the following manner. First, a load/eject button on the front panel of the optical disc drive is pressed to drive a loading/ejecting mechanism of the optical disc drive such that a tray connected to the loading/ejecting mechanism is pushed out of an opening of the optical disc drive. Then, an optical disc is placed on the tray, and the load/eject button is pressed again, thus driving the loading/ejecting mechanism to pull the tray back into the optical disc drive and allowing the optical disc drive to read/write data from/into the optical disc according to a reading/writing instruction of the computer.

In addition, after the tray is pushed out by pressing the load/eject button, it is a common design for the optical disc drive to automatically withdraw the tray if the tray has stayed outside the opening of the optical disc drive for a predetermined time without the load/eject button being pressed again. However, some optical disc drives which do not have such mechanisms for automatically withdrawing the pushed-out trays.

Conventional trays are usually made of a low resilience material and have a thickness (at the thinnest portion) that ranges from about 0.8 mm to 1.2 mm, the overall mechanical strength of such trays is not strong enough to withstand a large bending force. Therefore, if a tray which has been pushed out from the optical disc drive is inadvertently bumped by the user, or if a heavy object is dropped on the pushed-out tray, the chances are the tray will deform or even break due to the excessive transient stress. Should it happen, the optical disc drive is no longer good for use and has to be replaced. In addition, the sharp edges of the broken tray may cut or injure the user, thus raising safety issues. Moreover, if an important optical disc is supported on the tray while the tray breaks, the edges of the broken tray may damage the optical disc such that the valuable data stored therein is lost beyond recovery.

Hence, the issue to be addressed by the present invention is to improve the conventional optical disc drive trays so that they are prevented from breaking when impacted and that the optical discs supported on the trays are thus protected from damage.

### BRIEF SUMMARY OF THE INVENTION

In view of the aforementioned drawbacks of the conventional optical disc drive trays, the inventor of the present invention conducted extensive research and experiment and finally succeeded in developing a breakproof tray structure of an optical disc drive as disclosed herein. It is hoped that, with the present invention, tray damage attributable to human errors can be avoided, and users are prevented from injury which may otherwise result from the sharp edges of broken trays.

It is an object of the present invention to provide a breakproof tray structure of an optical disc drive, wherein the tray structure includes a tray and a resilient member. The resilient member has one side connected to an end of the tray and an opposite side connected to a loading/ejecting mechanism of the optical disc drive. The resilient member is made of a flexible material such as rubber. If the tray, in a state in which it has been pushed out from an opening of the optical disc drive by the loading/ejecting mechanism, is subjected to an external force, the resilient member will deform elastically while absorbing the force. In consequence, the external force is converted into elastic energy of the resilient member to effectively prevent the tray from breaking under an otherwise excessive stress, and once the external force applied to the tray is removed, the resilient member returns to its original shape. Thus, the tray will not break even if it is accidentally bent by the user in the pushed-out state. In other words, tray damage due to human errors is effectively prevented. It follows that the costs otherwise required for buying a replacement of the optical disc drive is saved.

It is another object of the present invention to provide a breakproof tray structure of an optical disc drive, wherein the tray structure includes a tray, a hinge, and a torsion spring. The hinge has one side connected to an end of the tray and an opposite side connected a loading/ejecting mechanism of the optical disc drive. The torsion spring is mounted around a pivot of the hinge and has two ends pressing against the two sides of the hinge respectively. If the tray, in a state in which it has been pushed out from an opening of the optical disc drive by the loading/ejecting mechanism, is pushed downward by an external force, the tray will be rotated downward about the pivot of the hinge to not only prevent the optical disc supported on the tray from damage which may otherwise result from breaking of the tray, but also protect the user from injury which may occur from broken edges of the tray. As a result, the safety of use of the optical disc drive is substantially increased.

It is yet another object of the present invention to provide a breakproof tray structure of an optical disc drive, wherein the tray structure includes a tray. The tray has one end connected to a loading/ejecting mechanism of the optical disc drive and is made of a flexible material such as rubber. If the tray, in a state in which it has been pushed out from an opening of the optical disc drive by the loading/ejecting mechanism, is subjected to an external force, the tray will absorb the external force by virtue of its own flexibility and deforms elastically. Thus, the tray is prevented from breaking under an otherwise excessive stress.

### BRIEF DESCRIPTION OF THE SEVERAL VIEWS OF THE DRAWINGS

The invention as well as a preferred mode of use, further objects, and advantages thereof will be best understood by referring to the following detailed description of some preferred embodiments in conjunction with the accompanying drawings, wherein:

FIG. 1 is a perspective view of a first preferred embodiment of the present invention;

FIG. 2 is a perspective view of a second preferred embodiment of the present invention;

FIG. 3 is a side view of the second preferred embodiment of the present invention; and

FIG. 4 is a side view of a third preferred embodiment of the present invention.

### DETAILED DESCRIPTION OF THE INVENTION

During the years dedicated to the research and development of computer-related devices, the inventor of the present invention has noticed that the potential breakage problem of the trays of optical disc drives has yet to be properly solved and that, in consequence, trays featuring breakproof properties are not available on the market. Therefore, under the premise of preserving the existing tray structure as much as possible and causing no substantial increase in production costs, the inventor applies the principle of elastic buffer to realize the breakproof property of the tray of an optical disc drive.

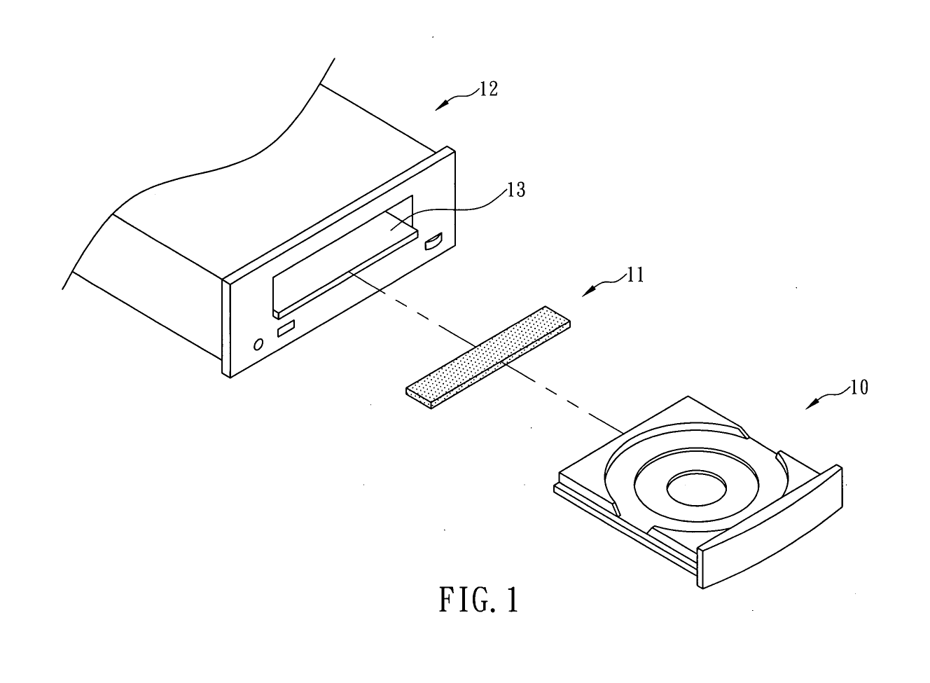

The present invention relates to a breakproof tray structure of an optical disc drive. Referring to FIG. 1, a tray structure according to a first preferred embodiment of the present invention includes a tray 10 and a resilient member 11, wherein the resilient member 11 has the same width as the tray 10. However, the present invention imposes no limitation on the width of the resilient member 11 is not limited in the present invention, and manufacturers may change the width of the resilient member 11 according to practical design needs. The resilient member 11 is made of rubber, which is a flexible material and is generally divided into natural rubber and synthetic rubber. Rubber has a modulus of elasticity of about 1˜10 MPa (1 Pa=1 N/m²), wherein modulus of elasticity is the ratio of stress and strain of an object within the range of elastic deformation. Rubber deforms elastically when subjected to an external force and converts the external force into elastic energy. Therefore, rubber is a good buffer material in industrial design and is widely used for cushioning.

As shown in FIG. 1, the tray 10 has an end (the left end) connected to a side (the right side) of the resilient member 11. The other side (the left side) of the resilient member 11 that is opposite the tray 10 is connected to a loading/ejecting mechanism 13 of an optical disc drive 12. The front end (the right end) of the loading/ejecting mechanism 13 is adjacent to an opening of the optical disc drive 12. The tray 10 is pushed out of or pulled into the optical disc drive 12 by the loading/ejecting mechanism 13. In the first preferred embodiment, the thickness of the resilient member 11 must be properly adjusted according to the modulus of elasticity of the resilient member 11 so that the resilient member 11 and the tray 10 stay in a horizontally connected state when pushed out or pulled in by the loading/ejecting mechanism 13. If the tray 10, in a state in which it has been pushed out of the optical disc drive 12, is accidentally bumped or bent by the user, the resilient member 11 will absorb the impact force and deform elastically, thereby converting the impact force into elastic energy. Since most of the impact force is absorbed by the resilient member 11, the tray 10 is effectively prevented from breaking under an otherwise excessive stress.

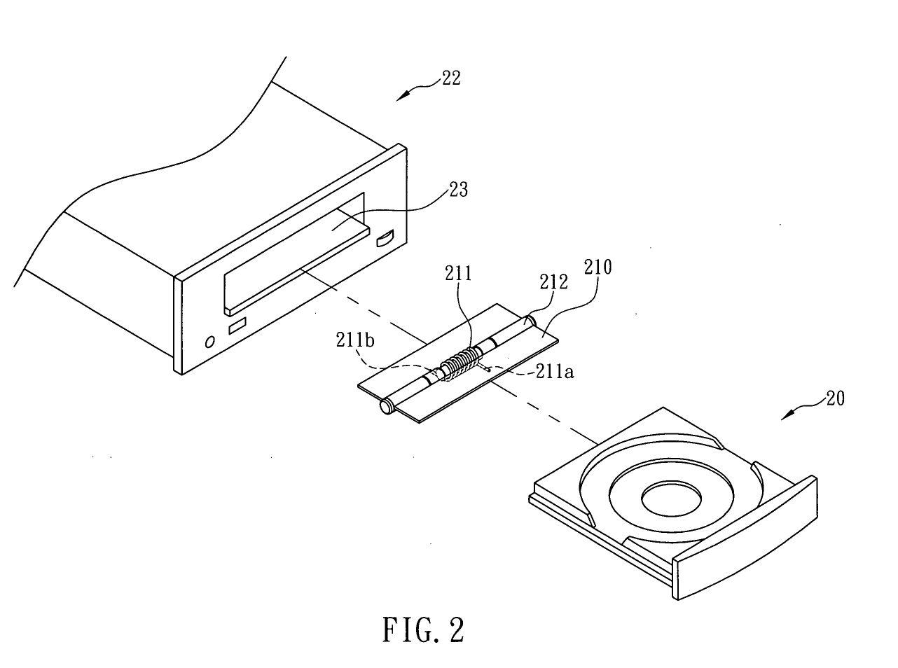

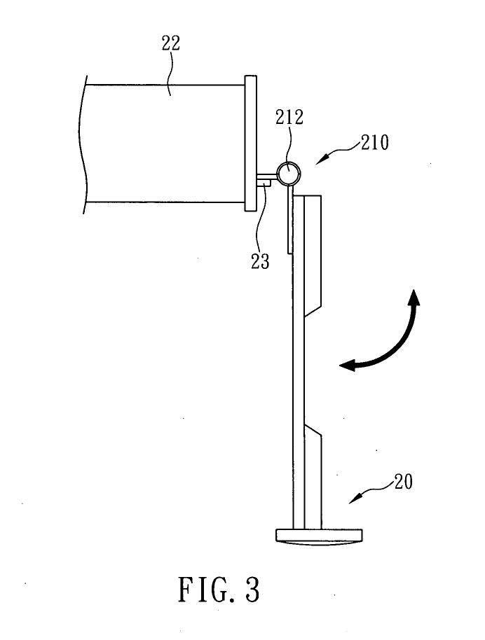

Apart from the resilient plate described above, the present invention may use other buffer elements to absorb the external force (impact force) applied to the tray. In a second preferred embodiment of the present invention as shown in FIG. 2, the buffer element used is composed of a hinge 210 and a torsion spring 211. The torsion spring 211 is mounted around a pivot 212 of the hinge 210, and the torsion spring 211 has one end 211a pressing against a first side (the right side) of the hinge 210 and an opposite end 211b pressing against a second side (the left side) of the hinge 210. The first side (the right side) of the hinge 210 is connected to one end of the tray 20 while the second side (the left side) of the hinge 210 is fixedly connected to the loading/ejecting mechanism 23 of the optical disc drive 22. If a heavy object is dropped on the tray 20 after the tray 20 is pushed out of the optical disc drive 22, the tray 20 will be rotated downward about the pivot 212 of the hinge 210, as shown in FIG. 3, while the torsion spring 211 (see FIG. 2) is twisted to absorb the force borne by the tray 20. Thus, the tray 20 is prevented from breakage which may otherwise occur if the tray 20 is directly subjected to the external force without rotation. Once the external force is released (e.g., after the heavy object leaves the tray 20), the tray 20 is rotated upward by the resilient force of the torsion spring 211 (see FIG. 2) back to the original position, thus allowing normal use of the optical disc drive 22.

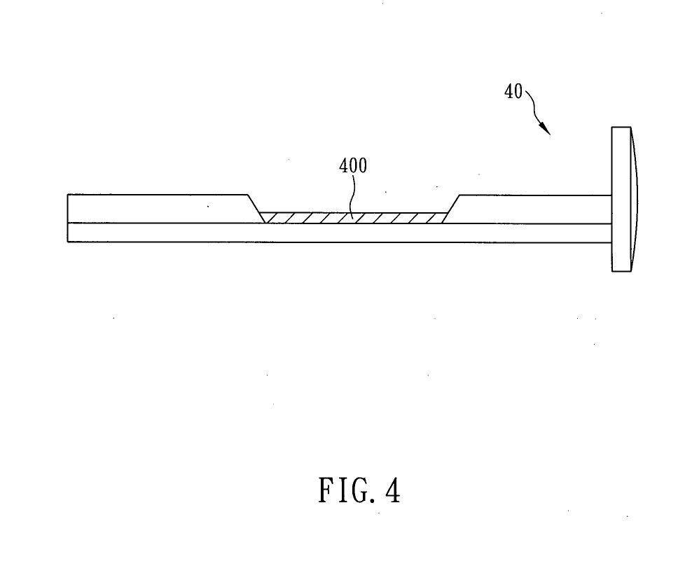

In addition to using the aforesaid buffer elements (i.e., the resilient member 11 and the hinge 210 mounted with the torsion spring 211) to absorb the impact force, it is also feasible in the present invention that the entire tray is made of a flexible material such as rubber so as to prevent the tray from breaking. Therefore, in a third preferred embodiment of the present invention as shown in FIG. 4, a tray 40 is made of rubber. However, as the rubber surface has a large coefficient of friction which may hinder the rotation of optical discs, the portion of the tray 40 that is configured to support an optical disc is coated with a protective layer 400. The protective layer 400 is formed of polytetrafluoroethylene (PTFE), which is a synthetic polymer with fluorine atoms replacing all the hydrogen atoms in polyethylene. PTFE is resistant to acid, base, and all kinds of organic solvents and is insoluble in almost all solvents. Also, PTFE is non-toxic in its normal condition, resistant to high and low temperatures, substantially insusceptible to changes in temperature, and suitable for use in a wide temperature range from −190° C. to 260° C. Besides, with the lowest coefficient of friction of all plastics, PTFE can serve as a solid lubricant and is an ideal oil-free lubricating material. Nevertheless, the present invention is not limited to the use of PTFE; the material of the protective layer 400 may vary based on cost considerations or practical design needs. All changes easily conceivable by a person skilled in the art should fall within the scope of the present invention.

To sum up, the first and second preferred embodiments use buffer elements (i.e., the resilient member 11 and the hinge 210 mounted with the torsion spring 211) to absorb impact forces; on the other hand, the tray in the third preferred embodiment is made entirely of rubber for absorbing external forces by virtue of the elasticity of rubber and thus preventing the tray from damage or breakage attributable to an external force exceeding the allowable limits of the tray. The technical features of the aforesaid embodiments not only prevent the tray of an optical disc drive from damage or breakage associated with improper external impact, but also protect important optical discs from damage, and the user from injury, which may otherwise result from the sharp edges of a broken tray. Consequently, the service life and safety of use of the tray of an optical disc drive is effectively increased.

While the invention herein disclosed has been described by means of specific embodiments, numerous modifications and variations could be made thereto by those skilled in the art without departing from the scope and spirit of the invention set forth in the claims.

What is claimed is:

1. A breakproof tray structure of an optical disc drive, the tray structure comprising:
a tray; and
a buffer element having a side connected to an end of the tray and an opposite side connected to a loading/ejecting mechanism of the optical disc drive such that the buffer element and the tray can be pushed out of the optical disc drive while staying in a horizontally connected state, wherein the buffer element can absorb an external force applied to the tray and hence deform elastically, and once the external force is removed, the buffer element returns its original shape.

2. The tray structure of claim 1, wherein the buffer element is a resilient member.

3. The tray structure of claim 2, wherein the resilient member is made of rubber.

4. The tray structure of claim 1, wherein the buffer element is composed of a hinge and a torsion spring, the hinge being provided with a pivot and having a side connected to the end of the tray and an opposite side connected to the loading/ejecting mechanism, the torsion spring being mounted around the pivot of the hinge and having two ends pressing against the two sides of the hinge respectively.

5. A breakproof tray structure of an optical disc drive, the tray structure comprising:
a tray made of a flexible material and having an end connected to a loading/ejecting mechanism of the optical disc drive such that the tray can be pushed out of the optical disc drive while staying in a horizontal state, wherein the tray can absorb an external force applied thereto and hence deform elastically, and once the external force is removed, the tray returns its original shape.

6. The tray structure of claim 5, wherein the flexible material is rubber.

7. The tray structure of claim 6, wherein the tray has a portion configured to support an optical disc and coated with a protective layer.

8. The tray structure of claim 7, wherein the protective layer is formed of polytetrafluoroethylene (PTFE).
